(19) United States
(12) Patent Application Publication
(10) Pub. No.: US 2016/0180214 A1
(43) Pub. Date: Jun. 23, 2016

(54) SHARP DISCREPANCY LEARNING

(71) Applicant: Google Inc., Mountain View, CA (US)

(72) Inventors: Dimitri Kanevsky, Ossining, NY (US); Ignacio Lopez Moreno, New York, NY (US); Dmitrii Vladimirovich Ulianov, Moscow (RU)

(21) Appl. No.: 14/577,301

(22) Filed: Dec. 19, 2014

(51) Int. Cl. G06N 3/08; G10L 15/06; G06N 99/00

(52) U.S. Cl. CPC G06N 3/08; G06N 99/005; G10L 15/063

(57) ABSTRACT

Methods, systems, and apparatus, including computer programs encoded on computer storage media, for training a neural network. One of the methods includes training a neural network using sharp discrepancy learning by providing training data to the neural network, calculating a gradient using a sharp discrepancy output layer objective function to classify the neural network parameters for correct and incorrect network model states, and training the neural network using the gradient to determine a probability that data received by the neural network has features similar to key features of one or more keywords or key phrases.

### BACKGROUND

Automatic speech recognition is one technology that is used in mobile devices. One task that is a common goal for this technology is to be able to use voice commands to wake up and have basic spoken interactions with the device. For example, it may be desirable to recognize a “hotword” that signals that the mobile device should activate when the mobile device is in a sleep state.

Training speech recognition models for decoding and identification tasks is based on learning parameters for correct and incorrect model states in neural networks. The training may include selecting one model from a set of allowed models that minimizes some cost criterion, often achieved through the employment of some form of gradient descent algorithm.

### SUMMARY

In general, one innovative aspect of the subject matter described in this specification can be embodied in methods that include the actions of providing training data to a neural network that includes an output layer and one or more hidden layers, each of the hidden layers comprising multiple nodes and corresponding parameters; calculating a gradient for the neural network by applying a sharp discrepancy output layer objective function to the output layer, wherein the sharp discrepancy output layer objective function is dependent on the training data and parameters; and training the neural network using the gradient to determine a probability that data received by the neural network has features similar to key features of one or more keywords or key phrases, wherein training the neural network using the gradient comprises using the gradient to update the parameters. Other embodiments of this aspect include corresponding computer systems, apparatus, and computer programs recorded on one or more computer storage devices, each configured to perform the actions of the methods. A system of one or more computers can be configured to perform particular operations or actions by virtue of software, firmware, hardware, or any combination thereof installed on the system that in operation may cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The method may comprise providing the trained neural network for use in a speech recognition system, wherein the speech recognition system uses sharp discrepancy learning on real data.

In certain aspects, calculating the gradient for the neural network by applying a sharp discrepancy output layer objective function to the output layer may comprise calculating the gradient of a cross-entropy function.

In some implementations, the sharp discrepancy output layer objective function may comprise a class of functions with a fraction whose denominator is a product of shifted label scores over a set of labels that correspond to a set of states that are designated as incorrect states. In additional aspects the label scores each comprise an exponential of a product of a label, parameter matrix and training data point.

In some implementations the class of sharp discrepancy objective functions may comprise functions with a fraction whose numerator is a non-negative label score associated with a state that is designated as a correct state.

In some implementations calculating the gradient for the neural network may comprise calculating each component of the gradient separately. In certain aspects calculating the gradient may comprise calculating each component of the gradient in parallel.

In some implementations, the neural network may comprise a deep neural network.

In some implementations, the neural network may comprise a deep belief network.

In certain aspects, the method may comprise providing training data to a neural network wherein the training data comprises a plurality of feature vectors and a plurality of label vectors that each indicate whether the corresponding feature vector corresponds to i) one of the keywords or key phrases, or ii) not.

In some implementations each of the plurality of feature vectors may represent a different portion of an audio waveform from a received digital representation of speech. In certain aspects the digital representation of speech may comprise recorded speech data.

In some implementations each of the plurality of label vectors may correspond to one of the feature vectors and may specify a probability distribution for whether the corresponding feature vector corresponds to i) one of the keywords or key phrases, or ii) not. In certain aspects the probability distribution may comprise a multinomial distribution.

In additional aspects training the neural network using the gradient may comprise iterating the parameter updates until an end criteria is met. The method may comprise calculating, using the hidden layers, an exponential of a product of a value of one of the parameters and a point from the training data.

The subject matter described in this specification can be implemented in particular embodiments so as to realize one or more of the following advantages. In some implementations, a system trained with sharp discrepancy learning determines numerical values of parameters for correct states that are more separated, for example in terms of numerical distances, from the numerical values of parameters for alternative, incorrect states to reduce a quantity of inference errors at an inference stage, for example a recognition or identification stage. In some implementations, a system trained with sharp discrepancy learning may be beneficial, for example, in situations where there may not be enough training data, or the training data is difficult to process and is too noisy to easily learn distinctions between correct and incorrect states, or both. In some implementations, a system trained with sharp discrepancy learning may produce better separation of parameter space for correct states versus incorrect states that may lead to higher speech recognition, higher speech identification accuracy, or both. In some implementations, a system trained with sharp discrepancy learning may achieve an improvement in recognition accuracy and relative improvement for speaker identification using noisy languages, e.g., Icelandic, French and English.

In some implementations, a system trained with sharp discrepancy learning allows for faster training of speech recognition models. In some implementations, a system trained with sharp discrepancy learning allows for parallelization of the computation of the gradient that is used to train the model, and may improve the computational efficiency, time, and/or resources required. In some implementations, a system trained with sharp discrepancy learning uses an objective function that allows parallel computation of second order statistics to reduce computation resource use.

In some implementations, a system trained with sharp discrepancy learning may be simple to implement using existing infrastructures of training modules and/or may be applied to almost any existing system for training neural networks, for example in settings such as voice search command control, transcription systems, vision processing, image recognition, voice and image identification, machine learning technologies. In some implementations, a system may use sharp discrepancy learning when training a recurrent neural network.

In some implementations, a system trained with sharp discrepancy learning may produce a training model that differs from existing training models produced by standard means. In some implementations, a system trained with sharp discrepancy learning may be used in conjunction with standard training methods and models, for example to reduce a decoding error rate.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example of a speech recognition process with a neural network.

FIG. 2 is a flow diagram of a general scheme for sharp discrepancy learning.

FIG. 3 is a flow diagram of an efficient gradient computation.

FIG. 4 is a block diagram of a computing system that can be used in connection with the computer-implemented methods described in this document.

Like reference numbers and designations in the various drawings indicate like elements.

### DETAILED DESCRIPTION

A speech recognition model using neural networks is trained by learning parameters for correct and incorrect model states. A neural network receives training data, for example recorded speech data aligned with words that represent the speech content, given by a collection of feature vectors. Each feature vector is connected to a label vector that specifies a probability distribution. The neural network may include several layers, and each layer may be associated with a set of parameters that are learned during the training process. In some implementations, the neural network may be a deep neural network or a deep belief network.

The output layer of the neural network uses an objective function to classify parameters for correct and incorrect model states. A sharp discrepancy objective function is constructed for a neural network with a softmax output and cross entropy function. The sharp discrepancy objective function is obtained from a typical objective function, for example log-likelihood or cross entropy, comprising a sum of terms for all frames of audio data in a training dataset. For each frame, this term can be represented as a function of a ratio of a numerator and a denominator. In the case of a softmax activation function, the ratio is given by Equation (1). The numerator is generally some non-negative parameter value associated with a correct state and the denominator is a sum of parameter values for a set of incorrect states.

$${softmax}_{i} = \frac{exp ( {θ}_{i}^{T} {x}^{t} )}{{\sum }_{k = 1}^{N} ( 1 + exp ( {θ}_{k}^{T} {x}^{t} ) )} \qquad ( 1 )$$

The sharp discrepancy objective function replaces the sum in Equation (1) with a product of shifted parameter values. The denominator becomes larger, thus increasing the discrimination between correct and incorrect parameter values achieved during training, and in turn producing more robust and accurate speech and identification recognition.

The neural network applies a cross-entropy error criterion that results in a minimization problem to be solved for the output layer of the neural network with respect to the parameter values. The minimization problem may include minimizing a linear combination of the logarithm of the sharp discrepancy objective function.

The neural network minimizes the cross-entropy by computing a gradient of the cross-entropy, that is by computing first and second order statistics. The particular form of the sharp discrepancy function enables such calculations to be computed independently and therefore the computation of the gradient may be parallelized. The neural network updates the parameters accordingly, and the process repeats until all data is processed or until some END criteria is reached.

A user device may use the neural network to analyze received audio waveforms and determine if a sequence of frames from an audio waveform include a digital representation of a specific keyword or key phrase that correspond with the training data set. Upon determination that a sequence of frames contains a digital representation of a specific keyword, or has probability above a threshold probability that the sequence of frames contains a digital representation of a specific keyword, the user device may perform an action that corresponds with the one of the specific keywords. For instance, the user device may exit a standby state, launch an application, or perform another action.

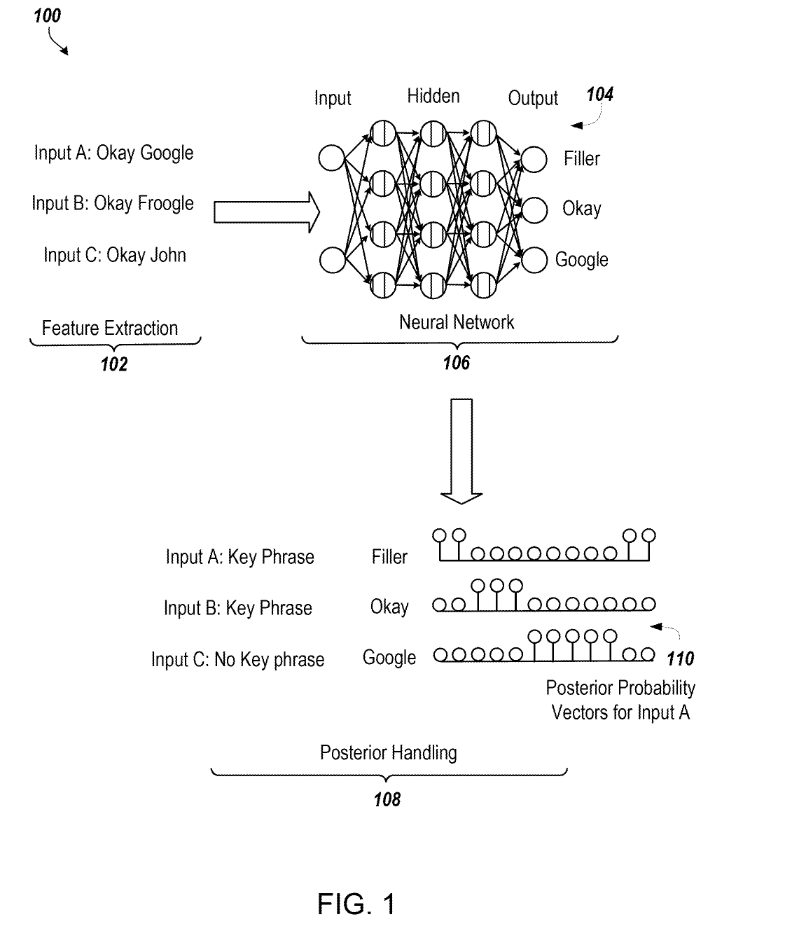

FIG. 1 is an example of a speech recognition process 100 with a neural network. The speech recognition process 100 includes a feature extraction phase 102, a neural network phase 106, and a posterior handling phase 108. The feature extraction phase 102 performs voice-activity detection and generates a feature vector for every frame of audio data, e.g., from an audio waveform. For example, the speech recognition process 100 may receive a digital representation of speech, e.g., as a continuous stream of data, and split the stream into multiple frames of data, e.g., where each frame is associated with 10 milliseconds of audio stream data.

The feature extraction phase 102 may analyze each of the frames to determine feature values for the frames and places the features values in feature vectors which can be stacked, e.g., using left and right context of adjacent feature vectors, to create a larger feature vector.

The neural network phase 106 provides a feature vector, for a single frame or a stacked vector for multiple frames, to the neural network 104 that is trained to predict posterior probabilities from the features values included in a feature vector. The posterior probabilities correspond with entire words or sub-word units for the keywords or key phrases and represent the probability that a keyword or key phrase is included in a frame or multiple consecutive frames.

The posterior handling phase 108 may combine the posterior probabilities from multiple feature vectors into a confidence score used to determine whether or not a keyword or a key phrase was included in the digital representation of speech, e.g., included in the frames that correspond with the feature vectors.

For example, as shown in FIG. 1, the speech recognition process 100 may receive a digital representation of speech for a window of time where the digital representation of speech includes data representing the key-phrase “okay google”. The speech recognition process 100 divides the window into twelve frames. The feature extraction phase 102 determines features values for each of the twelve frames, creates feature vectors with the corresponding feature values for the twelve frames, and provides the twelve feature vectors to the neural network phase 106.

In the example shown in FIG. 1, the neural network phase 106 uses a neural network 104 that was trained to identify probabilities for three categories of content including the probability that a feature vector corresponds with the keywords “okay”, and “google”, and the probability that the feature vector does not correspond with either of the keywords, e.g., and is “filler”. The neural network 104 analyzes each of the twelve feature vectors and generates frame-level posterior probabilities for each of the three categories. The neural network phase 106 provides the frame-level posterior probabilities to the posterior handling phase 108.

The posterior handling phase 108 combines the probabilities for the frames to determine a final confidence score for the received window. For example, the posterior handling phase 108 combines the probabilities and determines that the window included “filler” in the first two frames, the keyword “okay” in the next three frames, e.g., where each of the frames is associated with a different portion of the keyword, the keyword “google” in frames six through ten, and “filler” in the remaining two frames. The determination may be specific to a particular frame or for the entire window.

In some implementations, the feature extraction phase 102 analyzes only the portions of a digital representation of speech that are determined to include speech to reduce computation. For example, the feature extraction phase 102 may include a voice-activity detector that may use thirteen-dimensional perceptual linear prediction (PLP) features and their deltas and double-deltas as input to a thirty-component diagonal covariance Gaussian Markov Model, to generate speech and non-speech posteriors for each frame. The feature extraction phase 102 may perform temporal smoothing on the speech and non-speech posteriors to identify regions where the speech posteriors exceed a threshold and the corresponding frame is likely to include speech.

For frames that include speech regions, the feature extraction phase 102 may generate acoustic features based on forty-dimensional log-filterbank energies computed every ten milliseconds over a window of twenty-five milliseconds. The feature extraction phase 102 may stack contiguous frames to add sufficient left and right context, e.g., as the speech recognition process 100 receives additional data and the analysis of the frames progresses, and provide feature vectors for the stack of frames to the neural network 104. For example, the input window may be asymmetric since each recently received frame may add about ten milliseconds of latency to the speech recognition process 100. In some implementations, the speech recognition process 100 stacks ten recently received frames and thirty previously received frames.

The neural network phase 106 may utilize a fully connected deep neural network 104 with L hidden layers and n hidden nodes per layer where each node computes a non-linear function of the weighted sum of the output of the previous layer. In some implementations, some of the layers may have a different number of nodes.

The nodes in the output layer may use an objective function, for example a softmax activation function, to determine an estimate of the posterior probability of each output category. The nodes in the hidden layers of the neural network 104 may use rectified linear unit (ReLU) functions to determine output using the received input from the previous layer or the values from the feature vectors, e.g., for the initial layer of nodes.

In some implementations, the size of the neural network 104 is determined based on the number of output categories, e.g., keywords and/or key phrases and filler.

The output categories of the neural network 104 can represent entire words or sub-word units in a keyword or a key-phrase. For instance, during keyword or key-phrase detection, the output categories of the neural network 104 can represent entire words. The neural network 104 may receive the output categories during training and the output categories may be context dependent, e.g., specific to a particular device, software application, or user. For example, the output categories may be generated at training time via forced alignment using a standard Gaussian mixture model based large vocabulary continuous speech recognition system, e.g., a dictation system.

The neural network 104 is trained to determine a posterior probability yₜⁱ for the i^{th} output category and the t^{th} frame xₜ, where the values of i are between 1 and N, with N the number of total categories. In some implementations, 1 corresponds with the category for non-keyword content, e.g., content that corresponds with the “filler” category. The parameters, e.g., the weights and biases, of the neural network 104, θ, may be estimated by minimizing the cross-entropy training criterion over the labeled training data (xₜ, yₜ)ₜ₌₂^{T} using Equation (2) below.

$${min}_{{θ}_{L}} J ( {θ}_{L} ) = {min}_{{θ}_{L}} {\sum }_{t = 1}^{T} {\sum }_{i = 1}^{N} {y}_{t}^{i} log \frac{{y}_{t}^{i}}{{\hat{y}}_{t}^{i}} \qquad ( 2 )$$

In Equation (2), ŷₜⁱ is the network output for the physical state i and the t^{th} training example and is dependent on the parameter vector connected to the last L^{th} neural network layer θ_{L}.

In some implementations, the neural network 104 may be trained with a software framework that supports distributed computation on multiple CPUs in neural networks. In some implementations, the neural network 104 is trained using asynchronous stochastic gradient descent with an exponential decay for the learning rate.

The neural network phase 106 provides the posterior probabilities to the posterior handling phase 108. The posterior handling phase 108 may smooth the posterior probabilities 110 over a fixed time window of size Wₛₘₒₒₜₕ to remove noise from the posterior probabilities, e.g., where posterior probabilities corresponding with multiple frames are used to determine whether a keyword was included in a window. For example, to generate a smoothed posterior probability y′ₜⁱ from the posterior probability yₜⁱ, for the i^{th} output category and the t^{th} frame xₜ, where the values of i are between 0 and N−1, with N the number of total categories, the posterior handling phase 108 may use Equation (3) below.

$${{y}^{′}}_{t}^{i} = \frac{1}{t - {h}_{smooth} + 1} {\sum }_{k = {h}_{smooth}}^{t} {y}_{k}^{i} \qquad ( 3 )$$

In Equation (3), hₛₘₒₒₜₕ=max {1, t−wₛₘₒₒₜₕ+1} is the index of the first frame within the smoothing window. In some implementations, wₛₘₒₒₜₕ=30 frames.

The posterior handling phase 108 may determine a confidence score for the t^{th} frame xₜ within a sliding window of size wₘₐₓ using Equation (4) below.

$$confidence = \sqrt[N - 1]{{\prod }_{i = 1}^{N - 1} {max}_{{h}_{max} \leq k \leq t} {{y}^{′}}_{k}^{i}} \qquad ( 4 )$$

In Equation (4), y′ₖⁱ is the smoothed state posterior, and hₘₐₓ=max {1, t−wₘₐₓ+1} is the index of the first frame within the sliding window. In some implementations, wₘₐₓ=100. In some implementations, when Equation (4) does not enforce the order of the sub-word unit sequence, stacked feature vectors are fed as input to the neural network 104 to help encode contextual information.

In some implementations, the speech recognition process 100 is a large vocabulary conversational speech recognition process.

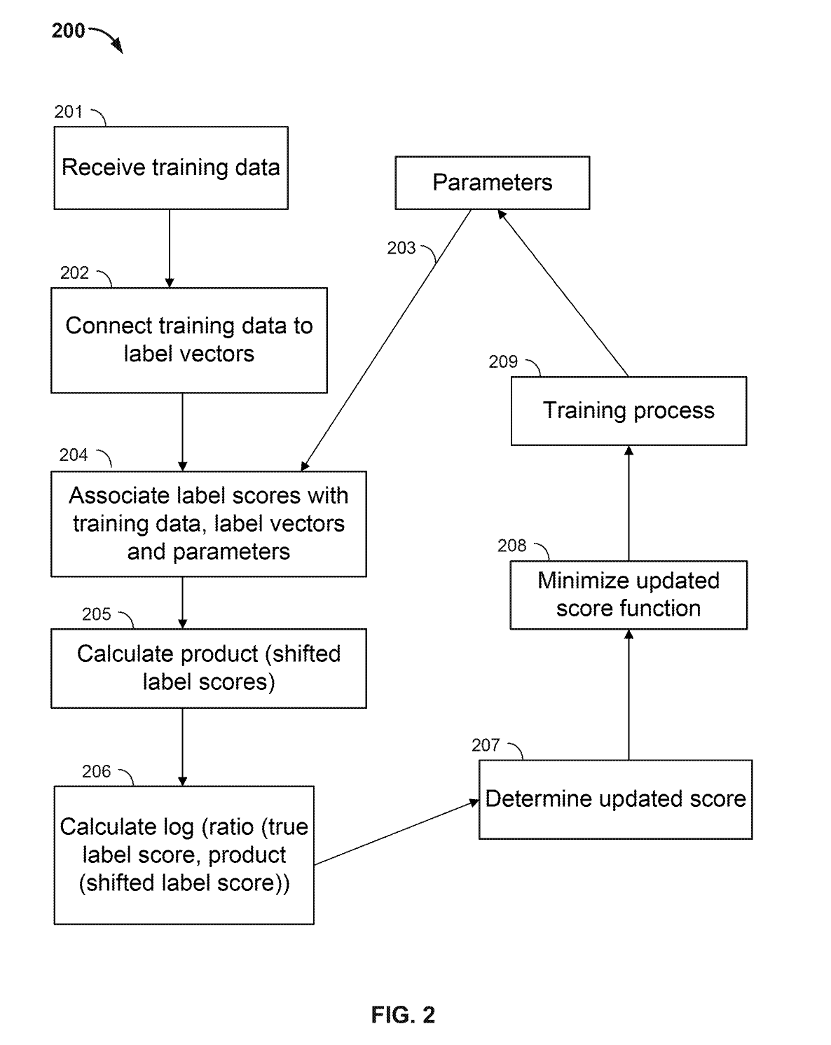

FIG. 2 is a flow diagram of an example process 200 for sharp discrepancy learning. For example, the process 200 can be implemented in the neural network phase of the process 100.

The process receives some training data (201). For example, the speech recognition process 100 may receive a digital representation of speech as a continuous stream of data that is aligned with words that represent speech content. The continuous stream of data may also be split into multiple frames of data, for example, where each frame is associated with 10 milliseconds of audio stream data. The data can be represented as a collection of vectors, which are referred to as data points, as shown in Equation (5).

χ={x₁,x₂, . . . ,x_{T}} (5)

The process connects each data point xₜ, where tε{1,2, . . . , T}, with a label vector yₜ that specifies a probability distribution (202), for example a multinomial distribution over N physical states. The process provides the training data set {xₜ, yₜ}ₜ₌₁^{T} where ∀t: Σⱼ₌₁^{N}[yₜ]ⱼ=1, called the labeled training data, to the neural network for training.

The process connects a parameter vector θ_{L} to the output layer of the neural network (203), the entries of which may include a set of initial values or a set of previously learned values. The entries of the parameter vectors, also called weights, are trained using the training data set. The parameters may include parameters in a deep neural network, or the parameters of a hidden Markov model, for example.

The process associates a collection of label scores with the data points, labels and parameters (204). The label scores are exponentials of a product of a corresponding label, parameter matrix θ and a data point, that is {e^{y}^{ₜ}^{θx}^{ₜ}}ₜ₌₁^{T}≡{e^{θ}^{ₜ}^{x}^{ₜ}}ₜ₌₁^{T}. In some implementations, an index in a label vector may have an entry equal to 1. This entry, iₜ, may be referred to as a true label of a data point xₜ. The label score associated with the true label of a data point and corresponding parameters is given by e^{θ}^{ᵢ}t^{x}^{ₜ}.

The process may then use the set of label scores to calculate a product of shifted label scores over a set of labels for some parameter and data point (205), for example Πₖ₌₁^{N}(1+exp(θₖₜ^{T}xₜ)). The shift may take an arbitrary value. In some implementations the shift may equal 1.

The process may calculate the ratio of a true label score and the product of shifted label scores over a set of labels for some parameter and data point (206), as given by Equation (6).

$${\hat{y}}_{t}^{{i}_{t}} = \frac{exp ( {θ}_{{i}_{t}}^{T} {o}_{t} )}{{\prod }_{k = 1}^{N} ( 1 + exp ( {θ}_{kt}^{T} {o}_{t} ) )} \qquad ( 6 )$$

In Equation (6), ŷₜⁱ^{ₜ} represents the network output for the physical state iₜ and the t^{th} training example, and is dependent on the parameter vector θ. The physical state iₜ is the true label of the data point xₜ.

The process uses the calculated logarithms of values in Equation (6) to determine an updated score comprising a sum of label scores taken over a subset of data points and parameters (207). In some implementations, the neural network employs an objective function for prediction and minimizes cross-entropy loss. For example, using the cross-entropy error criterion may result in the minimization problem given by Equation (7).

$${min}_{{θ}_{L}} H ( y , \hat{y} ) = - {min}_{{θ}_{L}} {\sum }_{t = 1}^{T} {\sum }_{k = 1}^{N} {y}_{t}^{k} ln {\hat{y}}_{t}^{k} \qquad ( 7 )$$

The process minimizes the updated score function as given by Equation (7) with respect to the parameter vector θ_{L} (208). Minimization may be achieved using various methods, examples of which include calculating a gradient using first and second order statistics or computing a stochastic gradient.

The process applies a training process whereby the calculated gradient is used to train and update the parameter vector and determine a set of minimizing parameters (209). The process associates a collection of label scores with the data points, labels and updated parameters and may iterate until some END criteria is met.

In many cases the denominator in Equation (6) is larger than the denominator for a standard softmax activation function, which instead comprises a sum of label scores. Therefore, a larger discrepancy may be achieved using the sharp discrepancy objective function. In some implementations it may be beneficial to take a weighted sum of a sharp discrepancy function with a softmax activation function. The sharp discrepancy function may also be applied to other neural network typologies such as recurrent neural networks. It may also be extended with other objective functions that involve probabilities comprising ratios with a sum in the denominator, by replacing the sums with products of shifted parameter values.

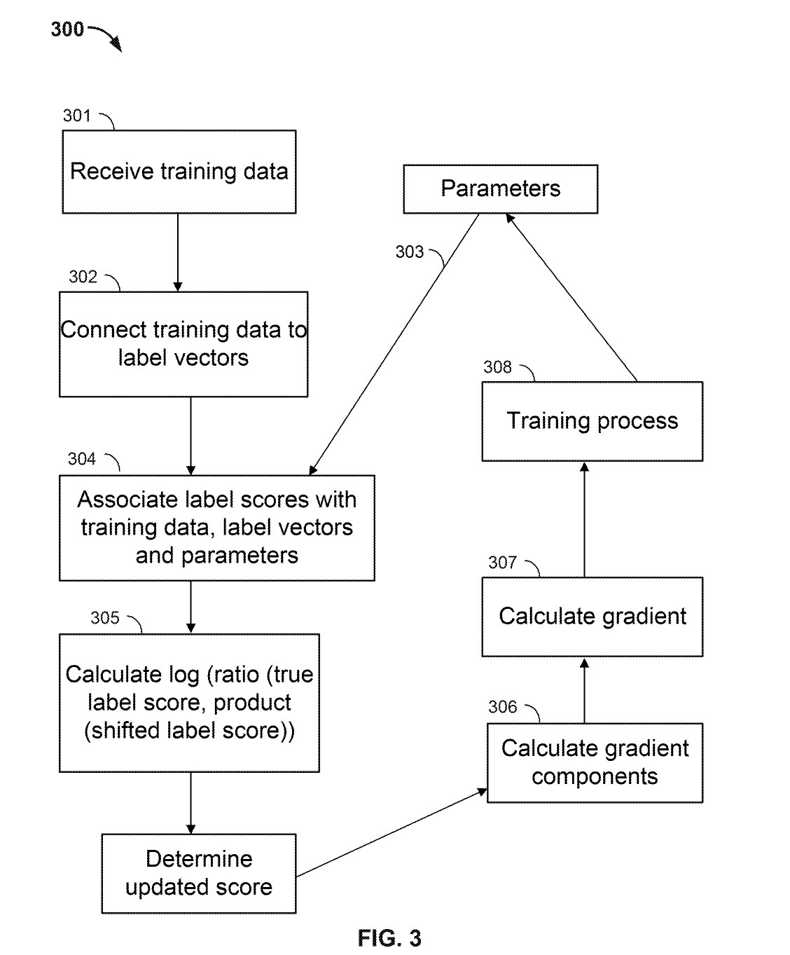

FIG. 3 is a flow diagram of an efficient gradient computation used for training the neural network parameters.

The process receives some training data (301). For example, the speech recognition process 100 may receive a digital representation of speech as a continuous stream of data that is aligned with words that represent speech content. The continuous stream of data may also be split into multiple frames of data, for example, where each frame is associated with 10 milliseconds of audio stream data. The data can be represented as a collection of vectors, which are referred to as data points, as shown in Equation (5).

The process connects each data point xₜ, where tε{1,2, . . . , T}, with a label vector yₜ that specifies a probability distribution (302), for example a multinomial distribution over N physical states. The process provides the training data set {xₜ, yₜ}ₜ₌₁^{T} where ∀t: Σⱼ₌₁^{N}[yₜ]ⱼ=1, called the labeled training data, to the neural network for training.

The process connects a parameter vector θ_{L} to the output layer of the neural network (303), the entries of which may include a set of initial values or a set of previously learned values. The entries of the parameter vectors, also called weights, are trained using the training data set. The parameters may include parameters in a deep neural network, or the parameters of a hidden Markov model, for example.

The process associates a collection of label scores with the data points, labels and parameters (304). The label scores are exponentials of a product of a corresponding label, parameter matrix θ and a data point, that is {e^{y}^{ₜ}^{θx}^{ₜ}}ₜ₌₁^{T}≡{e^{θ}^{ₜ}^{x}^{ₜ}}ₜ₌₁^{T}. In some implementations, an index in a label vector may have an entry equal to 1. This entry, iₜ, may be referred to as a true label of a data point xₜ. The label score associated with the true label of a data point and corresponding parameters is given by e^{θ}^{ᵢ}t^{x}^{ₜ}.

The process may then use the set of label scores to calculate a product of shifted label scores over a set of labels for some parameter and data point, for example Πₖ₌₁^{N}(1+exp(θₖₜ^{T}xₜ)). The shift may take an arbitrary value. In some implementations the shift may equal 1.

The process may calculate the ratio of a true label score and the product of shifted label scores over a set of labels for some parameter and data point (305), as given by Equation (6).

The process uses the calculated logarithms of values in Equation (6) to determine an updated score comprising a sum of label scores taken over a subset of data points and parameters. In some implementations, the neural network employs an objective function for prediction and minimizes cross-entropy loss. For example, using the cross-entropy error criterion may result in the minimization problem given by Equation (7).

The process minimizes the cross entropy function given by Equation (7), for example by calculating a gradient vector whose components are the partial derivatives of the cross entropy function with respect to each parameter and use the gradient to update the parameter vector. Using the sharp discrepancy objective function as an output layer activation the cross-entropy may be written as given by Equation (8), since the logarithm of the product of scores can be split into a sum or logarithm of individual scores.

$$\begin{matrix}H ( y , \hat{y} ) = {\sum }_{t = 1}^{T} {\sum }_{k = 1}^{N} {y}_{t}^{k} {\sum }_{j = 1}^{N} ln ( 1 + exp ( - {y}_{t}^{j} {θ}_{k}^{T} {x}_{t} ) ) , where \\ ∀ t \text{:} {y}_{t} ∈ {\{ - 1 , 1 \}}^{N} ; {y}_{t}^{k} = - 1 , k \neq j ; {y}_{t}^{k} = 1 , k = j\end{matrix} \qquad ( 8 )$$

As shown by Equation (8), the cross entropy is a linear function with respect to the logarithm. The complete gradient vector may therefore be computed as a sum of individual gradients corresponding to each component of the gradient vector.

The process calculates the gradient components (306). In some implementations, the labels yₜ are hard and may be represented by sparse normalized vectors consisting of a single non-zero entry. In such a setting, the gradient components are given by Equation (9).

$$\begin{matrix}\frac{\partial {\hat{y}}_{j}^{i}}{\partial ( {θ}_{l}^{T} {x}^{i} )} = {\hat{y}}_{j}^{i} \frac{1}{1 + exp ( {θ}_{j}^{T} {x}^{i} )} \\ \frac{\partial {\hat{y}}_{j}^{i}}{\partial ( {θ}_{l}^{T} {x}^{i} )} = - {\hat{y}}_{j}^{i} \frac{exp ( {θ}_{l}^{T} {x}^{i} )}{1 + exp ( {θ}_{l}^{T} {x}^{i} )}\end{matrix} \qquad ( 9 )$$

The process passes the gradient components to the updated gradient block, which collects the individual components and is then used to calculate a complete gradient (307).

The process applies a training process whereby the calculated gradient is used to train and update the parameter vector and determine a set of minimizing parameters (308). The process associates a collection of label scores with the data points, labels and updated parameters and may iterate until some END criteria is met (309).

In many cases Equation (9) shows the linear separation of indices that may be achieved using the described process. The gradient components may be calculated separately and in parallel, unlike a standard softmax scheme, for example, which requires the computation of each ŷⱼⁱ before computing the gradient. The parallelization of the computation of the gradient that is used to train the model may improve the computational efficiency, time and resources required by the system.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

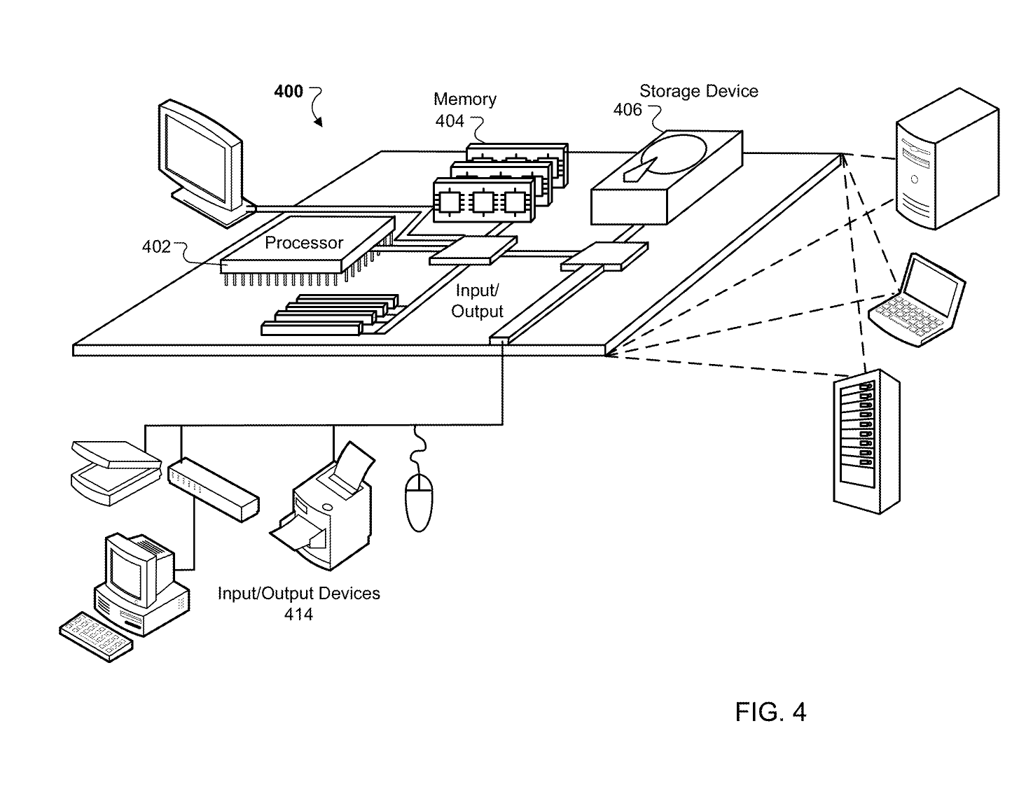

An example of one such type of computer is shown in FIG. 4, which shows a schematic diagram of a generic computer system 400. The system 400 can be used for the operations described in association with any of the computer-implement methods described previously, according to one implementation. The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
providing training data to a neural network that includes an output layer and one or more hidden layers, each of the hidden layers comprising multiple nodes and corresponding parameters;
calculating a gradient for the neural network by applying a sharp discrepancy output layer objective function to the output layer, wherein the sharp discrepancy output layer objective function is dependent on the training data and parameters;
training the neural network using the gradient to determine a probability that data received by the neural network has features similar to key features of one or more keywords or key phrases, wherein training the neural network using the gradient comprises using the gradient to update the parameters.

2. The method of claim 1, comprising providing the trained neural network for use in a speech recognition system, wherein the speech recognition system uses sharp discrepancy learning on real data.

3. The method of claim 1, wherein calculating the gradient for the neural network by applying a sharp discrepancy output layer objective function to the output layer comprises calculating the gradient of a cross-entropy function.

4. The method of claim 1, wherein the sharp discrepancy output layer objective function comprises a class of sharp discrepancy objective functions with a fraction whose denominator is a product of shifted label scores over a set of labels that correspond to a set of states that are designated as incorrect states.

5. The method of claim 4, wherein the label scores each comprise an exponential of a product of a label, parameter matrix and training data point.

6. The method of claim 4, wherein the class of sharp discrepancy objective functions comprise functions with a fraction whose numerator is a non-negative label score associated with a state that is designated as a correct state.

7. The method of claim 1, wherein calculating the gradient comprises calculating each component of the gradient separately.

8. The method of claim 1, wherein calculating the gradient comprises calculating each component of the gradient in parallel.

9. The method of claim 1, wherein the neural network comprises a deep neural network.

10. The method of claim 1, wherein the neural network comprises a deep belief network.

11. The method of claim 1, wherein the training data comprises a plurality of feature vectors and a plurality of label vectors that each indicate whether the corresponding feature vector corresponds to i) one of the keywords or key phrases, or ii) not.

12. The method of claim 11, wherein each of the plurality of feature vectors represent a different portion of an audio waveform from a received digital representation of speech.

13. The method of claim 12, wherein the digital representation of speech comprises recorded speech data.

14. The method of claim 11, wherein each of the plurality of label vectors corresponds to one of the feature vectors, and specifies a probability distribution for whether the corresponding feature vector corresponds to i) one of the keywords or key phrases, or ii) not.

15. The method of claim 14, wherein the probability distribution comprises a multinomial distribution.

16. The method of claim 1, wherein training the neural network using the gradient comprises iterating the parameter updates until an end criteria is met.

17. The method of claim 1, comprising calculating, using the hidden layers, an exponential of a product of a value of one of the parameters and a point from the training data.

18. A system comprising:
one or more computers and one or more storage devices storing instructions that are operable, when executed by the one or more computers, to cause the one or more computers to perform operations comprising:
providing training data to a neural network that includes an output layer and one or more hidden layers, each of the hidden layers comprising multiple nodes and corresponding parameters;
calculating a gradient for the neural network by applying a sharp discrepancy output layer objective function to the output layer, wherein the sharp discrepancy output layer objective function is dependent on the training data and parameters;
training the neural network using the gradient to determine a probability that data received by the neural network has features similar to key features of one or more keywords or key phrases, wherein training the neural network using the gradient comprises using the gradient to update the parameters.

19. The system of claim 18, wherein the sharp discrepancy output layer objective function comprises a class of sharp discrepancy objective functions with a fraction whose denominator is a product of shifted label scores over a set of labels that correspond to a set of states that are designated as incorrect states.

20. A computer-readable medium storing software comprising instructions executable by one or more computers which, upon such execution, cause the one or more computers to perform operations comprising:
providing training data to a neural network that includes an output layer and one or more hidden layers, each of the hidden layers comprising multiple nodes and corresponding parameters;
calculating a gradient for the neural network by applying a sharp discrepancy output layer objective function to the output layer, wherein the sharp discrepancy output layer objective function is dependent on the training data and parameters;
training the neural network using the gradient to determine a probability that data received by the neural network has features similar to key features of one or more keywords or key phrases, wherein training the neural network using the gradient comprises using the gradient to update the parameters.
